(19) United States
(12) Patent Application Publication
(10) Pub. No.: US 2003/0171852 A1
(43) Pub. Date: Sep. 11, 2003

(54) Method for accessing a device belonging to a communications network in an automobile through an external device, and gateway

(76) Inventors: Vasco Vollmer, Gartow (DE); Wolfgang Baierl, Remshalden (DE)

Correspondence Address: KENYON & KENYON, ONE BROADWAY, NEW YORK, NY, 10004, US

(21) Appl. No.: 10/276,028

(22) PCT Filed: Apr. 7, 2001
(86) PCT No.: PCT/DE01/01384

(30) Foreign Application Priority Data
May 9, 2000 (DE) 100 22 422.9

(51) Int. Cl. B60R 16/00; G05B 19/042

(52) U.S. Cl. 701/1; 307/10.1

(57) ABSTRACT

A method a method of accessing a device in a communications network in a motor vehicle via an external device (1) is described, a software element being transmitted to the external device in the case of authorized access to a device in the communications network to permit control of the device in the communications network by the external device. A gateway checks on whether access is possible, either checking directly with the device requested or via the system manager. Security in communication between the external device and the device to be controlled is achieved by an additional encryption and/or a specified validity period of the software element transcribed to the external device. If there is no software element for a device to be controlled, such a software element is created by using a control module and data stored in the device. A bus system, preferably according to IEEE 1394, is used as the communications network. This method increases security while at the same time using a less complex gateway.

### BACKGROUND INFORMATION

The present invention is directed to a method of accessing a device in a communications network in a motor vehicle via an external device and/or a gateway according to the preamble of the independent patent claim.

It is known that a gateway is used when an external device accesses a communications network in a motor vehicle to prevent negative effects on the availability and stability of a communications network and the components connected to the communications network. The gateway thus assumes security functions.

### ADVANTAGES OF THE INVENTION

The method according to the present invention for accessing a communications network in a motor vehicle via an external device and the gateway according to the present invention having the features of the independent patent claim has the advantage over the related art that a data protection and security function is achieved in a simple manner by a software element which is transcribed to the external device by the gateway. This allows the gateway to be less complex, because communication between the external device and the device to be controlled is determined by the software element. This is related to the fact that the security functions for accessing a certain device of the communications network are distributed to the software element to thereby relieve the load on the gateway. In addition, such a system has a distributed intelligence and thus the individual components are less complex. A distributed intelligence means that not all of the security functions are concentrated in the gateway or another function or another device. For each device which permits access by an external device, there is a software element to assume these security functions. The security function and thus the intelligence constituting the security are distributed to the various software elements. This increases the degree of distribution of the intelligence in the communications network.

Advantageous improvements on the method characterized in the independent patent claim for accessing a device in a communications network in a motor vehicle via an external device and/or the gateway are possible through the measures and refinements characterized in the dependent claims.

It is especially advantageous that the gateway inquires directly or via a system manager as to the possibility of accessing the requested device. As an alternative, the inquiry may also be sent directly to the device requested. This information is thus advantageously not concentrated in the gateway, so the gateway design may be simplified.

In addition, it is advantageous that increased security is achieved through encryption of the data transmitted to and from the external device and the particular device queried in the communications network. In particular, this makes it difficult for this communication to be intercepted.

It is also advantageous that the software element transcribed to the external device has a specified validity period. This results in the software element not being available for an indefinite period of time, which increases security against abuse of the transcribed software element. Since the external device must initiate a new inquiry after the validity period has elapsed, the access authorization is checked again. This may be accomplished automatically through a cyclic inquiry to the gateway or to the system manager or to the device requested. This makes it possible to prevent further use of the transcribed software element, in particular in the case of unauthorized access.

In addition, it is advantageous to create the software element using a platform-independent programming language, so the software element will be capable of running in any hardware environment. However, if the software element is created with a platform-specific programming language, the software element will run more rapidly and efficiently on the corresponding external devices. This is advantageous due to the fact that a platform-specific programming language suitable for precisely this external device has been used.

In addition, it is advantageous that the software element is created for a device connected to the communications network of the vehicle by using a control module and data of this device. This permits an adaptive procedure which yields a self-configurable communications network.

In addition, it is advantageous that the communications network is operated as a bus system, so that additional components are easily connectable. A bus system is also advantageous in minimizing wiring complexity. It is advantageous in particular if the bus system is designed according to the IEEE 1394 standard. This is a serial bus developed for automotive engineering in particular. This creates a large area of applications of the method according to the present invention for accessing a device in a communications network in a motor vehicle via an external device.

It is also advantageous that the external device has means for communication with the gateway and/or means for using the software element, making it possible to utilize the method according to the present invention.

### DRAWING

Exemplary embodiments of the present invention are illustrated in the drawing and explained in detail in the following description.

FIG. 1 shows the design of a communications network, and

FIG. 2 shows a flow chart of the method according to the present invention.

### DESCRIPTION

In the automotive industry, multimedia components are being integrated into motor vehicles to an increasing extent. However, more and more portable and thus external devices are accessing devices connected to a communications network in the vehicle. For example, one may wish to compare an address database with a corresponding database in the motor vehicle with the help of a portable digital assistant. Other examples include transcribing data, in particular audio and/or multimedia data or navigation data created on a home computer.

However, to prevent negative effects on the availability and stability of the communications network, access by these external devices is accomplished via a gateway. A gateway is a module, implemented either through hardware or software, interconnecting two different communications networks or communication components. Security functions in particular are to be provided in such a gateway, so that access to a communications network does not have unwanted effects.

Therefore, a method of accessing a device in a communications network in a motor vehicle via an external device is implemented according to the present invention, the gateway of the communications network handling the access inquiry of an external device in such a way that the gateway checks on whether access to a requested device within the communications network is possible, and if this is the case, then a software element is transmitted to the external device to permit communication with the device requested. If no access is possible, the external device is informed of this fact.

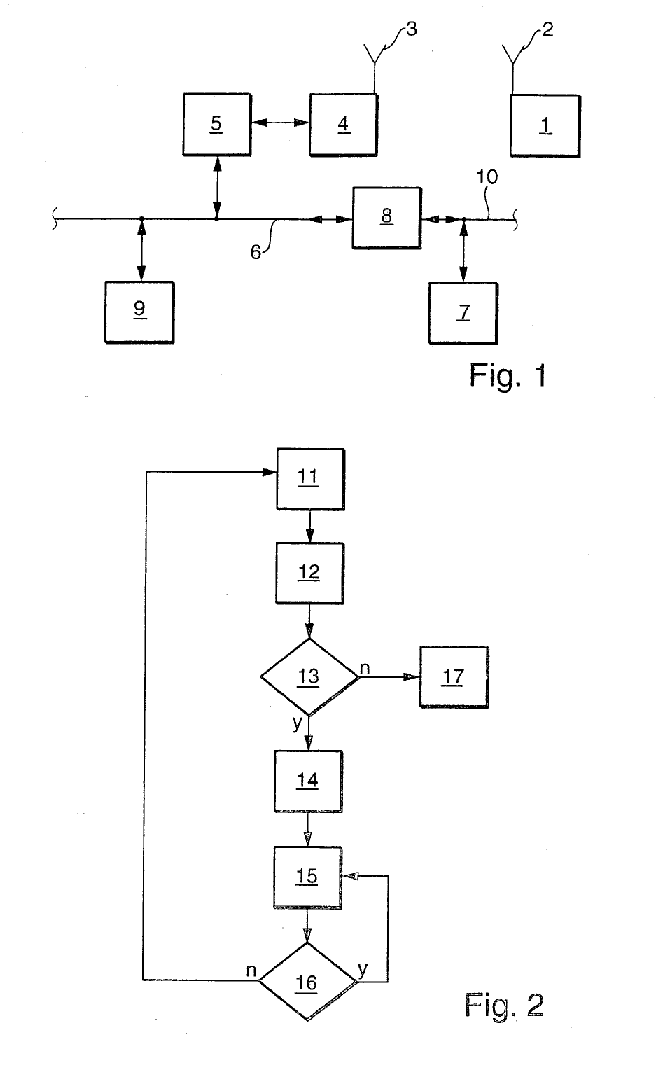

FIG. 1 shows the design of a communications network in a motor vehicle. An external device 1 having an antenna 2 for sending and receiving data wishes to access a device in the communications network. A wireless connection is used here, but alternatively, an infrared connection or a cable or plug connection is also possible.

The communications network has as the first two devices a gateway 4 having an antenna 3 for sending and receiving and a system manager 5 connected to the gateway via a first data input/output. System manager 5 is connected via its second data input/output to a bus system 6 to which a CD player 9 is also connected via its data input/output. Other components may also be connected to bus system 6, in particular other multimedia components such as a navigation device or a car radio. Devices connected to bus 6 have bus controllers which regulate communications over the bus.

Bus 6 here is a bus system according to IEEE 1394 standard. According to this standard, various devices or nodes are connected via an optical fiber or a cable having four to six strands. A node may optionally be designed as a end piece or as a relay node. It is therefore possible to construct a suitable topology of the communications network. A node processes the information, which is provided with its own address. All information received by the node at a port is sent by the node via its other ports if a plurality of such ports are present, as is the case with a relay node. According to IEEE 1394, the communications network is self-configuring, i.e., after a restart, all the nodes in the communications network send information about themselves to the communications network. A MOST bus may also be used as an alternative.

A gateway 8 is connected to bus system 6 via a data input/output. Gateway 8 is the interface between bus system 6 and another bus system 10. Gateway 8 is responsible for data transfer between these two bus systems. A positioning device 7, for example, is connected to bus system 10 here.

System manager 5, which is either a separate unit having its own hardware and software or a software program on a computer in the motor vehicle, controls components such as CD player 9 and positioning device 7. If there are no software elements for controlling these components, system manager 5 generates such a software element which allows such control by using a control module and data stored in the particular device. However, these software elements may also be used by other devices to control the particular devices. System manager 5 must ensure that two devices do not simultaneously access a device to be controlled.

The software element may be created by using a platform-independent code, so the software element will run on any hardware platform, or the software element may be created by using a platform-specific code, so that such a software element is created for certain external devices, e.g., a personal digital assistant, to run rapidly and without error on this particular device. This also has the advantage that only certain devices may access the communications network in the motor vehicle. Such devices include a personal digital assistant, a laptop, a notebook, and a cellular telephone in particular.

FIG. 2 shows a flow chart for the method according to the present invention for accessing a device in a communications network in a motor vehicle via an external device. In method step 11, external device 1 sends an inquiry to gateway 4 via the wireless interface indicating that it wishes to access a device of the communications network. Gateway 4 has a list of available components of the communications network which allow access by an external device. Gateway 4 transmits this list to external device 1 (method step 12). In method step 13, external device 1 indicates which device of the communications network it would like to control, namely CD player 9 in this case. In method step 13, gateway 4 then checks on whether access to CD player 9 is possible. Gateway 4 either has this information itself or gateway 4 sends an inquiry to system manager 5 or to the device to be controlled, CD player 9, itself.

If control by an external device is not possible, then in method step 17, external device 1 is notified that access is impossible. This may be due to a general non-availability of the device, or the external device may not be authorized to have access. In an inquiry by external device 1, the external device logs on. In certain devices or in all devices, a code query may be provided to prevent unauthorized access. This code query may also be performed by a chip which makes the communications network in the motor vehicle receptive as a whole to external access. To do so, the chip is either inserted into external device 1 or into a device of the communications network to permit authorized access and operation, similar to the use of a keycard with car radios today.

However, if access to CD player 9 via external device 1 is possible, then in method step 14, a software element that permits control of CD player 9 by external device 1 is transmitted from gateway 4 to external device 1. The software element is an executable data file usable only for communication with CD player 9. If there is no software element for CD player 9, system manager 5 is able to generate such a software element by using a control module and data stored in CD player 9. It is thus possible to generate the software element as needed and to save on memory resources.

Then in method step 15, control of CD player 9 by external device 1 is implemented via the software element transmitted. A check is performed in method step 16 to determine whether the software element is still valid. If this is the case, then in method step 15, the control of CD player 9 is continued. However, if the validity of the software element has expired, the system jumps back to method step 11 to make another request for control of CD player 9. Such a validity period may amount to one hour, for example.

The request after expiration of the validity period may also be performed cyclically in that external device 1 performs the check either at gateway 4 or system manager 5 or the device requested, namely CD player 9 here. Then the validity period is contained not in the software element itself, but instead in an instance in the communications network, which greatly increases security. This can be seen in particular with regard to manipulation of the validity period. If the determination of the validity period occurs in the communications network, an arbitrary change in the validity period is far more difficult than if the determination of the validity period takes place in external device 1. Manipulation is much simpler in the latter case.

In communication between external device 1 and CD player 9, the data may also be encrypted and/or decrypted by external device 1 and CD player 9. Encryption data may be transmitted with the software element to advantage, the encryption advantageously being linked to authorization for access to the communications network. This makes it much more difficult for the communication to be intercepted. The specified validity period may also be waived to reduce data traffic and create greater freedom for a user.

If a platform-independent code is used for the software element, the use of Java is advisable. If a platform-specific is code is used, then it is suitable to use codes for Palm OS or Windows CE in particular, because these are operating systems designed in particular for operation of portable devices, such as those mentioned above as embodiments for external device 1.

What is claimed is:

1. A method of accessing a device in a communications network in a motor vehicle by an external device (1), access by the external device (1) being controlled via a gateway (4) of the communications network,
wherein, following an access request by the external device (1), information regarding the available devices in the communications network is transmitted by the gateway (4) to the external device (1); the gateway (4) checks on whether the device requested by the external device (1) is allowing access; when access to the requested device is possible, the one software element is transmitted to the external device (1) to enable communication between the external device (1) and the requested device; and when no access to the requested device is possible, this is reported to the external device (1) by the gateway (4).

2. The method as recited in claim 1,
wherein the gateway (4) inquires of the requested device directly or via a system manager (5) regarding the possibility of access.

3. The method as recited in claim 1 or 2,
wherein encryption is used in communication between the external device (1) and the requested device.

4. The method as recited in claim 1 or 2,
wherein the software element is provided with a specified validity period; and after the validity period has elapsed, a new request by the external device (1) is performed to continue the communication.

5. The method as recited in claim 4,
wherein the validity period of the software element is checked by cyclic inquiries to the gateway (4) or the system manager (5) or the device requested.

6. The method as recited in one of claims 1 through 5, wherein the software element is created in a platform-independent programming language.

7. The method as recited in one of claims 1 through 5, wherein a platform-specific code is used for the software element.

8. The method as recited in one of the preceding claims, wherein if there is no software element for a device in the communications network, a new software element for the device is created on the basis of a control module and data stored in the device.

9. The method as recited in one of the preceding claims, wherein a bus system is used as the communications network.

10. The method as recited in claim 9, wherein a bus system according to IEEE 1394 is used as the bus system.

11. A gateway for controlling access by an external device to a device in a communications network in a motor vehicle, wherein information regarding the available devices in the communications network is transmittable from the gateway (4) to the external device (1) after an access inquiry by the external device (1); the gateway (4) is able to check on whether the device requested by the external device (1) allows access by the external device (1); in the case of a possible access to the device requested, a software element is transmittable from the gateway (4) to the external device (1) to permit communication between the external device and the device requested; and if no access is possible, the external device (1) may be notified of this by the gateway (4).

12. The external device as recited in claim 11, wherein the external device (1) has means for communication with the gateway (4) and means for use of the software element.
